(19) United States
(12) Patent Application Publication
(10) Pub. No.: US 2026/0040147 A1
(43) Pub. Date: Feb. 5, 2026

(54) IDENTIFICATION OF RADIO ACCESS NETWORK (RAN) RESOURCES FOR AI/ML COMPUTATION AVAILABILITY

(71) Applicant: T-Mobile USA, Inc., Bellevue, WA (US)

(72) Inventor: Zheng Cai, Fairfax, VA (US)

(21) Appl. No.: 18/789,477

(22) Filed: Jul. 30, 2024

(51) Int. Cl. H04W 28/18; H04W 16/14; H04W 76/10

(52) U.S. Cl. CPC H04W 28/18; H04W 16/14; H04W 76/10

(57) ABSTRACT

Wireless communication methods enhance computations in a radio access network (RAN). An example method involves a first RAN node receiving an interface setup message from a second RAN node, which includes resource capacity information. The interface setup message may relate to setting up a node-to-node interface between the first and second RAN nodes. The first RAN node transmits a resource status request and receives a resource status response containing resource availability information. This method allows for efficient resource management by utilizing neighboring cell site resources, thereby reducing data transmission capacity and latency.

### BACKGROUND

The radio access network (RAN) of a telecommunications network is responsible for connecting user devices to the core network, and it requires significant computational power to manage data traffic, ensure low latency, and maintain high-quality service. Computational power in the RAN is used for various tasks, including signal processing, data encryption and decryption, error correction, and resource allocation. These tasks are essential for maintaining seamless communication, optimizing network performance, and supporting a growing number of connected devices. Efficiently allocating and managing these computational resources across diverse and often heterogeneous environments (e.g., base stations and user devices) within the RAN is a complex challenge. Addressing these challenges is crucial for the effective operation and evolution of telecommunications networks.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIGS. 3A-3B are diagrams of example protocols for RAN resource identification and/or usage.

FIG. 4 is a flow diagram of a method for RAN resource identification and/or usage.

FIG. 5 is a diagram depicting a system of RAN nodes configured for RAN resource identification and/or usage.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present disclosure introduces solutions for enhancing the identification and utilization of computation resources in the RAN. Example systems and processes as disclosed herein enable the evolution of RANs to the implementation of next-generation functionalities, such as artificial intelligence and machine learning (AI/ML) tasks. RANs in the current generation and next generations may use these AI/ML tasks in each and every layer, from the edge for low latency to the application layer and services. The significant computation requirements associated with AI/ML tasks require solutions for how to use the existing computation resources in the RAN. Such solutions will not only enable computationally-intensive tasks such as those involving AI/ML but would also enhance other functionalities of the RAN.

Traditional methods of resource allocation and usage, which have focused on vertical computation resources from the application layer to the RAN and down to user devices, may be insufficient. These methods often result in slower processing times and reduced efficiency, particularly when leveraging the limited computational power of user devices. Existing research in distributed computing involves the application requesting services from an end-to-end central controller, which allocates resources across various domains such as RAN, transport, and core networks. Within each domain, further resource allocation is performed, for instance, with identifying resources within User Equipment (UEs) in the RAN. However, computationally intensive tasks (e.g., federated learning for AI/ML models) using UEs takes longer due to limited computation power in each UE and the number of UEs required, resulting in slower convergence.

The disclosed solutions address these challenges by enhancing protocols used by RAN nodes or base stations, thus enabling horizontality in resource usage and sharing. When communicating with neighboring cells, base stations can report their computational capability. In some implementations, this report is performed during a setup of a node-to-node interface (e.g., an Xn interface according to Third-Generation Partnership Project (3GPP) standards). In response to a particular base station reaching its computational limit, the particular base station may request current computational availabilities of other base stations based on their respective computational capabilities previously reported.

Therefore, the disclosed solutions do not rely upon a traditional central controller and may not require computing nodes to transmit their computational results back to such a central controller. As a result, the disclosed solutions can save a lot of data transmission capacity, as well as improve latency (as relying upon neighboring base stations for computational assistance is faster than techniques performed through a central controller).

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Example Implementations of Wireless Communications Systems

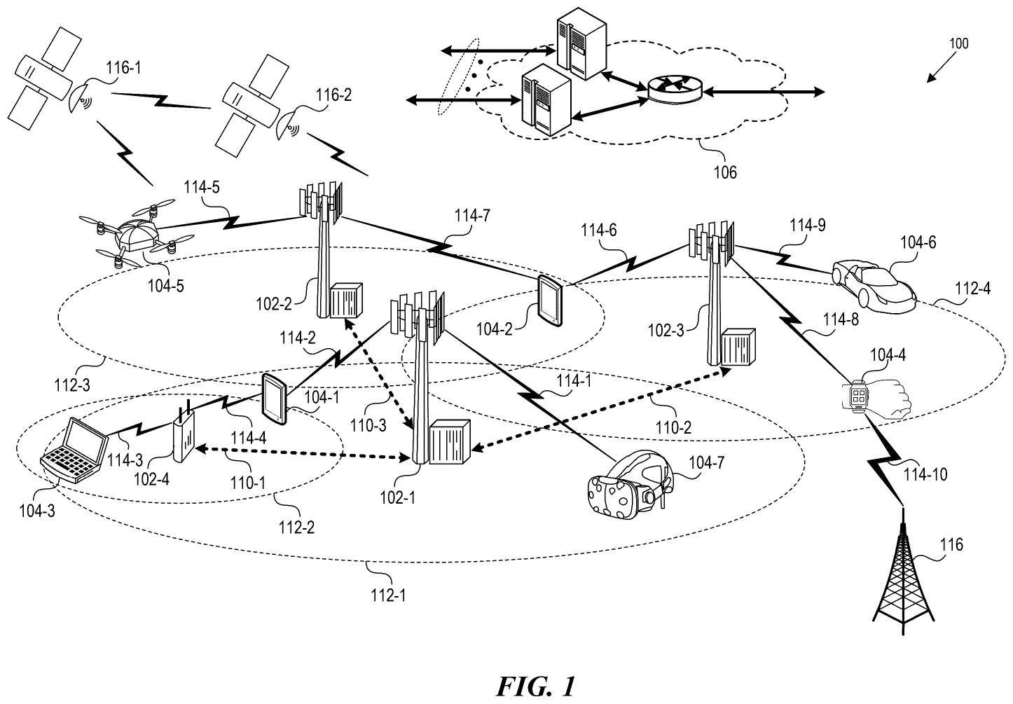

FIG. 1 is a block diagram that illustrates a wireless telecommunication network 100 (“network 100”) in which aspects of the disclosed technology are incorporated. For example, the network 100 is configured to enable RCS communication for its subscribers. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 operatively couples to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity (e.g., for RCS messaging), and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there are overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Example Implementations of 5G Core Network Functions

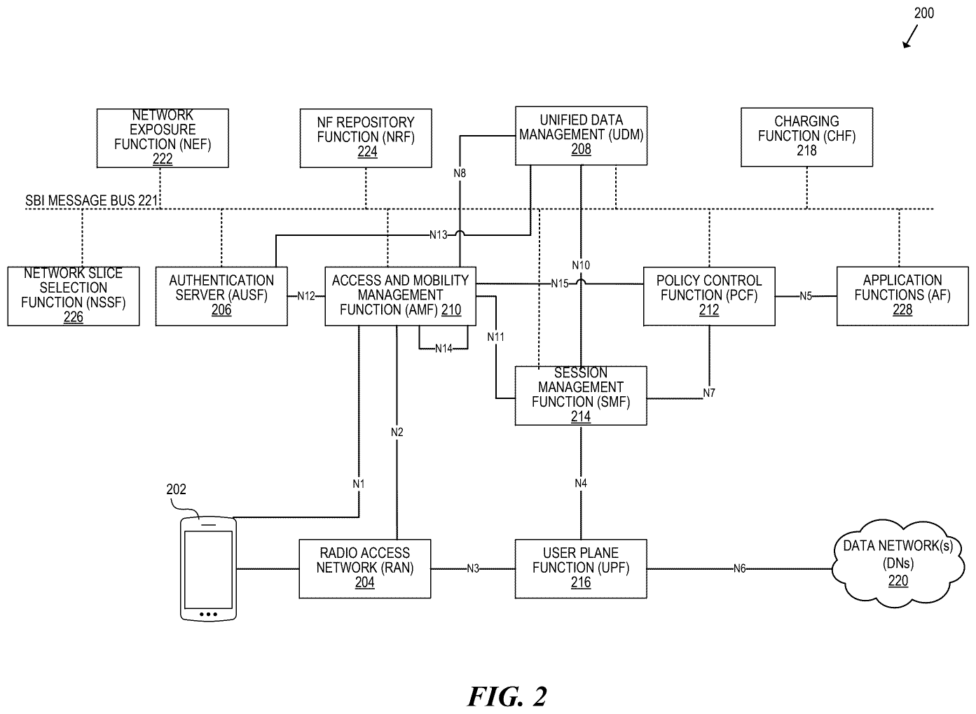

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNS) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Example Implementations for Diagnosing Network Service Provisioning

Solutions disclosed herein relate to identifying and using computation resources in a RAN. Network nodes (also referred to herein as RAN nodes, base stations, network access nodes, and the like) transmit, to one another, information relating to their respective resource capability or capacity. Then, when a network node is performing a computational task, the network node may request resource availability information associated with other network nodes based on the resource capability/capacity information that was previously communicated. The computational task may be allocated by the network node according to the resource availability information.

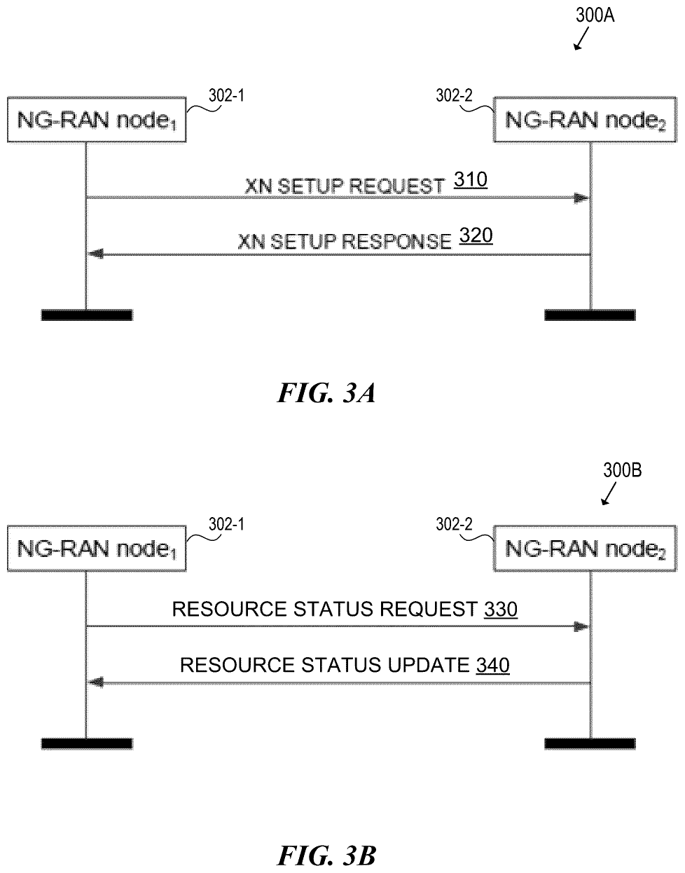

FIG. 3A is a diagram of an example protocol for RAN resource identification and/or usage. The protocol 300A may be performed with a first network node 302-1 and a second network node 302-2 in order to establish a communication interface between the first network node 302-1 and the second network node 302-2. For example, the communication interface established based on the protocol 300A may be a direct node-to-node interface that is used by the first network node 302-1 and the second network node 302-2 for RAN functionality. As another example, the communication interface established based on the protocol 300A is an Xn interface that may be used for the exchange of signaling information and the forwarding of packet data units (PDUs). In another example, the communication interface established based on the protocol 300A is an interface established between network nodes as defined for a 3G telecommunications network, a 4G/LTE telecommunications network, a 5G telecommunications network, a 6G telecommunications network, and/or the like, such as an X2 interface between eNBs in a 4G LTE network.

The protocol 300A includes the first network node 302-1 transmitting an interface setup request 310 to the second network node 302-2. In some examples, the interface setup request 310 may be an Xn setup request as defined in 3GPP Technical Specification TS 38.423, at least in Version 18.2.0. The protocol 300A further includes the second network node 302-2 transmitting an interface setup response 320 to the first network node 302-1. The interface setup response 320 transmitted by the second network node 302-2 enables the interface to be setup between the first network node 302-1 and the second network node 302-2.

According to example implementations, an interface setup message in the protocol 300A includes a computation capability information or an indication/request to provide computation capability information. In an example, the interface setup request 310 that is transmitted by the first network node 302-1 includes an indication/request for the second network node 302-2 to respond with its computation capability information. Accordingly, the interface setup response 320 transmitted by the second network node 302-2 may include computation capability information associated with the second network node 302-2. Therefore, the first network node 302-1 may obtain computation capability information associated with the second network node 302-2 based on requesting/trigger for the information during the protocol 300A.

In another example, the interface setup request 310 that is transmitted by the first network node 302-1 includes computation capability information associated with the first network node 302-1. Further, the interface setup response 320 that is transmitted by the second network node 302-2 includes computation capability information associated with the second network node 302-2. Therefore, the first network node 302-1 and the second network node 302-2 share their respective computation capabilities to the other during the protocol 300A.

In some implementations, the computation capability information associated with a network node describes an amount of computation resources that the network node may reserve for assisting other nodes with computational tasks. In some implementations, the network node has a dedicated or allocated amount of computation resources for RAN distributed computing. In some implementations, the computation capability information is a maximum amount of computation resources that the network node includes. In some implementations, the computation capability information indicates a capability that is specific to AI/ML-type computing, for example, resources associated with a neural processing unit (NPU).

In some implementations, the computation capability information includes at least one of (i) computation hardware type (e.g., graphical processing units (GPUs), NPUs, tensor processing units (TPUs)), (ii) computation processing capability (e.g., GigaFLOP/s), and (iii) memory bandwidth (Gbyte). For example, a network node may select one or more types of computation capability information to share, including these three types. An interface setup message may include computation capability information (including one or more of these different types of computation capability information) in a particular configuration (e.g., particular bitfields, information elements (IEs)). In one example, the interface setup message includes three bits for hardware type, four bits for processing capability, and four bits for memory bandwidth.

In some implementations, a network node can only request certain types of computation capability information from another network node. In some implementations, the indication/request included by the first network node 302-1 in the interface setup request 310 to the second network node 302-2 indicates one or more types of computation capability information to be shared. The indication/request may have a particular configuration (e.g., bitfield, IE) associated with the particular configuration of computation capability information in the interface setup response 320. In some implementations, the indication/request to provide computation capability information is associated with three bits in the interface setup request 310, where the first bit indicates whether a first type of computation capability information (e.g., hardware type) is requested, the second bit indicates a second type (e.g., GigaFLOP/s), and the third bit indicates a third type (e.g., Gbyte storage). For example, a value of ‘111’ (all three bits set to value ‘1’) indicates that all three types of computation capability information are requested. Therefore, the second network node 302-2 may parse and decode an indication/request included in the interface setup request 310 in order to determine what types of computation capability information to include in the interface setup response 320.

FIG. 3B is a diagram of an example protocol for RAN resource identification and/or usage. The protocol 300B may be performed with the first network node 302-1 and a second network nodes 302-2 in order to share present/current/real-time resource availability information. For example, the protocol 300B may be performed in order to determine whether a first network node 302-1 can allocate at least a portion of its computational or processing tasks to the second network node 302-2.

Current RAN protocols enable network nodes to communicate availability of radio resources, such as physical resource blocks (PRBs). This radio resource information can be communicated between network nodes via resource status messages, such as those defined in 3GPP TS 38.423 V18.2.0 Section 8.4.10. According to the technical solutions of the present disclosure, computation resource information (e.g., availability of computation resources) can additionally, or alternatively, be communicated between network nodes. In some implementations, resource status messages for communicating radio resource information are enhanced to further include computation resource information, for example, in a separate bitfield, information element, and/or the like. In some implementations, a separate resource status messaging is reserved for communicating computation resource information, and may be used separate from messaging for radio resource information.

The protocol 300B includes the first network node 302-1 transmitting a resource status request 330 to the second network node 302-2. The resource status request 330 includes an indication or request to share computation resource availability information. As referred to herein, availability may refer to an amount of computation resources that are not occupied at a present time (e.g., a time, a time duration or window). While computation resource capability information may be previously shared, portions of the computation resource capability of a network node may be occupied and in use over time, and thus unavailable for use by another network node.

The resource status request 330 may be configured to request for one or more types of resource availability information, including radio resource availability, computation resource availability, and types of computation resource availability. In some implementations, the resource status request 330 is configured to request for at least one of an available processing speed (e.g., GigaFLOP/s) or an available memory storage (e.g., Gbyte), which are types of computation resource availability. The resource status request 330 may further associate the requested information of the available processing speed and the available memory storage with a time duration. The resource status request 330 may request available processing speed for a particular time duration T and the available memory storage within the particular time duration T based on including the time duration T. The resource status request 330 may indicate (e.g., via certain bit values being set in a bitfield or IE) which types of resource availability information (e.g., available processing speed, available memory storage) should be returned to the first network node 302-1. In one example, an information element in a resource status request message is reserved for requesting types of computation resource availability (as opposed to radio resource availability), and the IE can include a first bit for requesting available processing speed and a second bit for requesting available memory storage (e.g., a bit configuration consistent with the indication of computation capability information in the interface setup message).

The protocol 300B includes the second network node 302-2 transmitting a resource status update 340 to the first network node 302-1. The resource status update 340 includes one or more types of resource availability information according to the resource status request 330. In one example, an information element in a resource status update/response message is reserved for computation resource availability (as opposed to radio resource availability), and the IE can include four bits for indicating available processing speed and four bits for available memory storage (e.g., a bit configuration consistent with the indication of computation capability information in the interface setup message). Subsequent to receiving the resource status update 340 from the second network node 302-2, the first network node 302-1 is aware of the resource availability at the second network node 302-2 for a time (e.g., time duration T).

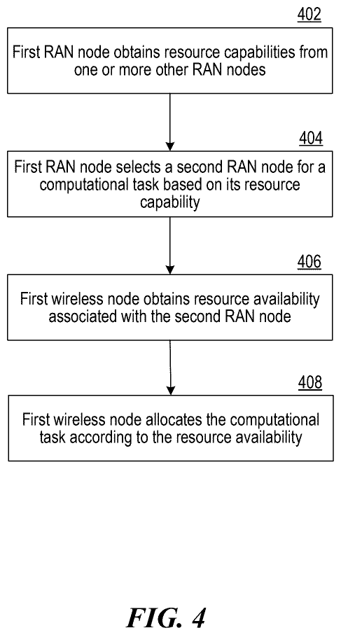

FIG. 4 is a flow diagram of a method for identifying available computational resources throughout a RAN. At 402, a first RAN node obtains resource capabilities from one or more other RAN nodes. The first RAN node may obtain the resource capabilities during an interface setup protocol (e.g., protocol 300A in FIG. 3A) with the one or more other RAN nodes. For example, the first RAN node obtains resource capabilities from other RAN nodes with which it has a direct node-to-node interface (e.g., an Xn interface in a 5G RAN). Therefore, in some examples, the one or more other RAN nodes include RAN nodes associated with cell sites neighboring a cell site provided by the first RAN node. In some implementations, the one or more other RAN nodes includes at least a first ring of neighboring cell sites surrounding the first RAN node.

In some implementations, the first RAN node locally stores the resource capabilities from the one or more other RAN nodes. For example, the first RAN node includes a database in which it stores the resource capability associated with each of the other RAN nodes, and the resource capability data stored in the database may be keyed according to an identifier associated with each other RAN node. In some implementations, the first RAN node also stores location information associated with each other RAN node, for example, whether another RAN node's cell site directly neighbors the first RAN node's cell site.

At 404, the first RAN node selects a second RAN node for a computational task based on its resource capability. The first RAN node may select the second RAN node based on a limited resource availability at the first RAN node to complete a computational task. The computational task may be a task related to an AI/ML model, such as a model inference task or a model training task, which may require higher levels of resources to efficiently process relative to non-AI/ML related tasks. In some implementations, the first RAN node receives an instruction from a radio intelligent controller (RIC) to perform the computational task within a time duration T. In some implementations, the RIC is a component or entity in an Open RAN (O-RAN) architecture that is configured for AI/ML related functions for the RAN. For example, the RIC can be a centralized AI/ML function where AI/ML model training is done in some centralized architecture implementations. In distributed architecture implementations, certain AI/ML tasks, such as training, are moved from the RIC to one or more RAN nodes according to the solutions disclosed herein. Distributed architecture implementations may be particularly prevalent in 6G networks.

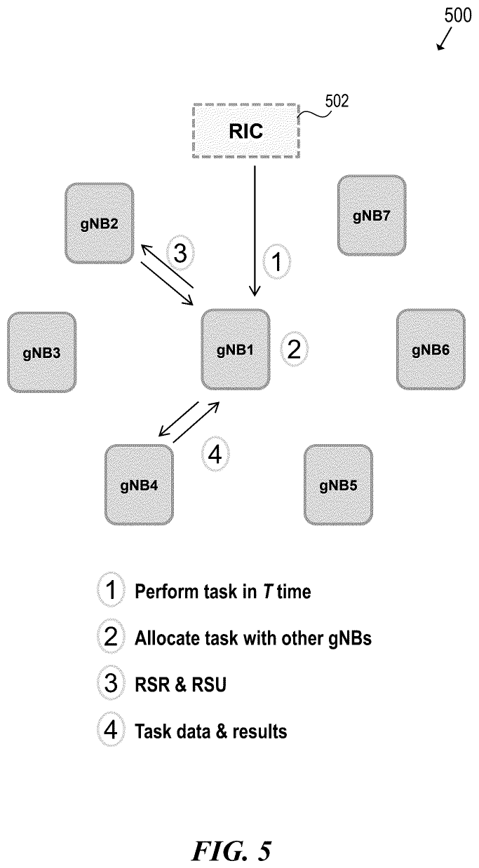

Referring to FIG. 5, an example RAN system 500 includes a RIC 502 transmitting a message to a first RAN node (“gNB1”) to perform an ML inference task in T time. In the example RAN system 500, the first RAN node operates a cell site that neighbors (e.g., is surrounded by) other cell sites associated with a plurality of other RAN nodes (e.g., gNB2 through gNB7). The first RAN node may have set up interfaces with the plurality of other RAN nodes and may have obtained resource capabilities of the plurality of other RAN nodes. In some implementations, the example RAN system 500 is an Open RAN system, and the RAN nodes (e.g., gNB1 through gNB7) may be radio units (RUs), distributed units (DUs), or centralized units (CUs). In some implementations, the first RAN node that allocates tasks to other nodes can be a CU, and the other nodes can be DUs.

In some examples, the first RAN node may determine or predict that it has limited resource availability to complete the computational task within the time duration T and accordingly determines to share or allocate at least a portion of the computational task with another RAN node. Thus, in some examples, the first RAN node selects the second RAN node in response to receiving an instruction or command to perform a computational task within a time duration T.

In some examples, the first RAN node may begin performing the computational task indicated by the RIC. The first RAN node's processing of the computational task may become limited or constrained due to other tasks that may be assigned with a greater priority. Due to constraints arising during the processing of the computational task, the first RAN node may determine or predict that it cannot complete the computational task within the time duration T and accordingly determines to share or allocate at least a portion of the computational task with another RAN node. Thus, in some examples, the first RAN node selects the second RAN node subsequent to beginning a processing of the computational task.

In other examples, the computational task indicated by the RIC to the first RAN node may be a distributed computing task, such as a federated machine learning task. Therefore, the first RAN node may determine that portions of the computational task should be allocated or distributed to other RAN nodes, unrelated to the resource availability at the first RAN node.

The first RAN node selects the second RAN node out of multiple RAN nodes based on the respective resource capabilities of the multiple RAN nodes. In some implementations, the first RAN node stores the respective resource capabilities of the multiple RAN nodes, and subsequently analyze the resource capabilities when it needs to allocate at least a portion of tis computational task. In some implementations, the first RAN node analyzes its own resource capability and availability to determine whether or how it should allocate its computational task. The selection of the second RAN node can be further based on the first RAN node analyzing and characterizing the computational task, such as by predicting a computation time based on training data size, hardware type, algorithms to be used, and/or the like.

Returning to FIG. 4, at 406, the first RAN node obtains a resource availability associated with the second RAN node according to its selection of the second RAN node. The first RAN node may obtain the second RAN node's resource availability, for example, during a protocol 300B as shown in FIG. 3B. For example, the first RAN node may query the second RAN node for its resource availability, and the second RAN node may report is resource availability in response to the query.

At 408, the first RAN node allocates at least a portion of the computational task to the second RAN node according to the second RAN node's resource availability. In some implementations, the first RAN node determines a portion of the computational task to allocate to the second RAN node, and may further allocate remaining portions of the computational task to other RAN nodes (based on their respective resource availabilities). In some implementations, the first RAN node determines not to allocate the portion of the computational task to the second RAN node if it determines that the second RAN node's resource availability is insufficient. In the depicted example of FIG. 5, the first RAN node (gNB1) queries the resource availability of gNB2 but allocates a portion of the computational task to gNB4 instead. The first RAN node may do so based on determining that the resource availability of gNB2 is insufficient, re-selecting gNB4 based on gNB4's resource capability, and determining that gNB4's resource availability is sufficient. In alternative examples, the first RAN node may allocate different portions of the computational task to both gNB2 and gNB4 based on their respective resource availabilities.

Allocating a portion of the computational task to another RAN node may include the other RAN node processing the portion of the computational task and returning any results or outputs to the first RAN node (or the RAN node allocating the portion of the computational task). In some implementations, the first RAN node allocates a portion of the computational task to the second RAN node with an indication of a time duration T1. In some implementations, the time duration T1 indicated to the second RAN node is less than the time duration T indicated to the first RAN node. This is configured for the second RAN node to complete its portion of the computational task earlier and the first RAN node to incorporate any results or outputs from the second RAN node in its own tasks.

It will be appreciated that, while the disclosed examples include a first RAN node allocating computational tasks to one second RAN node, other example implementations may include the first RAN node allocating a computational task to multiple second RAN nodes. Furthermore, a second RAN node processing a portion of a computational task allocated to itself may further allocate the portion of the computational task to a third RAN node, and so on, in some examples.

### Example Computer Systems

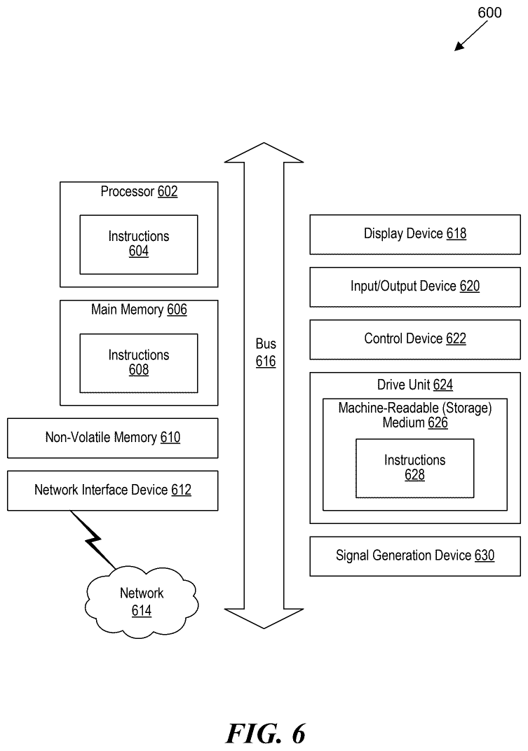

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A method for wireless communication, comprising:
receiving, at a first network node, an interface setup message from a set of other network nodes, wherein the interface setup message from each other network node comprises a resource capability information associated with the other network node;
selecting, by the first network node, a second network node from the set of other network nodes based on the resource capability information associated with each of the set of other network nodes; and
transmitting, by the first network node, a status request to a second network node for a resource availability information associated with a time duration.

2. The method of claim 1, further comprising:
receiving, at the first network node, a status message from the second network node in response to the status request, the status message comprising the resource availability information associated with the time duration; and
causing the second network node to perform a processing of at least a portion of a computational task, based on the resource availability information.

3. The method of claim 2, wherein the status message comprises one or more types of resource availability information based on the one or more types of resource availability information being indicated in the status request.

4. The method of claim 2, wherein the computational task is one of a model inference task or a model training task.

5. The method of claim 1, wherein the interface setup message includes one or more types of resource capability information based on the one or more types of resource capability information being indicated in an interface setup request transmitted by the first network node.

6. The method of claim 5, wherein the one or more types of resource capability information include at least one of a processing hardware type, a processing speed, or a memory storage capacity.

7. The method of claim 1, wherein the resource capability information associated with each other network node is stored at the first network node, and wherein the second network node is selected from the set of other network nodes further based on a determination that distribution of a computational task associated with the first network node is required.

8. The method of claim 7, wherein the determination that distribution of the computational task is required is based on a prediction that a resource availability at the first network node is insufficient to process the computational task within a task time duration.

9. The method of claim 1, wherein the set of other network nodes includes a plurality of neighboring network nodes having cell sites adjacent to a cell site associated with the first network node.

10. A non-transitory computer-readable storage medium storing instructions that, when executed by at least one hardware processor of a first network node associated with a radio access network (RAN), cause the first network node to perform operations comprising:
during a communication protocol with a second network node associated with the RAN, receive a resource capability information from the second network node, wherein the resource capability information includes at least one of (i) a processing hardware type at the second network node, (ii) a processing speed associated with the second network node, or (iii) a memory storage capacity associated with the second network node;
store the resource capability information received from the second network node in a database that includes resource capability indications associated with network nodes with which the first network node has a RAN interface established;
begin a processing of a computational task related to a machine learning model, wherein the computational task is one of an inference computational task using the machine learning model or a training computational task for the machine learning model;
in response to a determination that distribution of the computational task is required, selecting the second network node based on identifying the resource capability information associated with the second network node stored in the database;
query the second network node regarding a present resource availability for the second network node; and
based on the present resource availability for the second network node, cause at least a portion of the computational task to be processed at the second network node.

11. The non-transitory computer-readable storage medium of claim 10, wherein the communication protocol is configured for setting up the RAN interface between the first network node and the second network node.

12. The non-transitory computer-readable storage medium of claim 10, wherein the resource capability information from the second network node includes the at least one of the processing hardware type, the processing speed, or the memory storage capacity based on a resource capability request transmitted to the second network node during the communication protocol.

13. The non-transitory computer-readable storage medium of claim 10, wherein the network nodes with which the first network node has a RAN interface established include a plurality of neighboring network nodes having cell sites adjacent to a cell site associated with the first network node.

14. The non-transitory computer-readable storage medium of claim 10, further comprising:
determining that distribution of the computational task is required based on a predicted resource availability of the first network node being insufficient for completing the computational task within a time duration.

15. The non-transitory computer-readable storage medium of claim 10, further comprising:
determining that distribution of the computational task is required based on the computational task being a federated model learning task.

16. The non-transitory computer-readable storage medium of claim 10, wherein the processing of the computational task is begun in response to a command from a controller, wherein the command includes a time duration for the processing of the computational task.

17. A system associated with a first node of a radio access network (RAN), comprising:
at least one hardware processor; and
at least one non-transitory memory storing instructions that, when executed by the at least one hardware processor, cause the first node to:
obtain resource capability information associated with each of a set of other nodes of the RAN during a setup of node-to-node interfaces between the first node and each of the set of other nodes;
select a second node from the set of other nodes for a computational task based on the resource capability information associated with the second node;
query the second node for a resource availability information associated with a time duration; and
allocate at least a portion of the computational task to the second node based on the resource availability information.

18. The system of claim 17, wherein the first node selects the second node in response to predicting that the computational task will not be processed within a predefined processing time at the first node.

19. The system of claim 17, wherein the resource capability information associated with a given one of the other nodes includes a plurality of types of resource capability information indicated in a bitfield configuration of an information element.

20. The system of claim 17, wherein the second node is queries for the resource availability information based on a resource status request that is configured to request for both radio resource availability and computation resource availability.
